(19) United States
(12) Patent Application Publication
(10) Pub. No.: US 2014/0054939 A1
(43) Pub. Date: Feb. 27, 2014

(54) FAST ASSEMBLY MECHANISM AND INFANT SEAT WITH THE SAME

(71) Applicant: Jun-Jie Hu, Dongguan (CN)

(72) Inventor: Jun-Jie Hu, Dongguan (CN)

(21) Appl. No.: 13/749,705

(22) Filed: Jan. 25, 2013

(30) Foreign Application Priority Data
Aug. 27, 2012 (CN) 201210308853.2

(51) Int. Cl. A47D 1/10; F16B 17/00

(52) U.S. Cl. CPC A47D 1/10; F16B 17/00
USPC 297/256.16; 403/321

(57) ABSTRACT

The present invention discloses a fast assembly mechanism installed between a seat body and a seat frame. The fast assembly mechanism includes a pin and a connecting component. The pin is connected to the seat body, and the connecting component is slidably disposed on the seat frame. The connecting component includes an engaging portion and a release portion. The engaging portion is for engaging with the pin so as to engage the seat body with the seat frame, and the release portion is for separating the pin from the connecting component. When the seat body is engaged with the seat frame, the pin is aligned to the engaging portion and engaged with the engaging portion. When the seat body is detached from the seat frame, the connecting component is moved so that the pin is aligned to the release portion to separate from the connecting component.

### BACKGROUND OF THE INVENTION

1. Field of the Invention

The present invention relates a fast assembly mechanism and an infant seat with the same, and specifically relates to a fast assembly mechanism and an infant seat capable of implementing rapid engagement and detachment of a seat body and a seat frame by using a pin and a connecting component.

2. Description of the Prior Art

It is very common for an infant to use an infant seat. The infant seat provides a function for the baby to sit near a dinning table, so as to facilitate adults to take care of the baby. The infant seat is usually fixed on a seat frame. The infant seat with multi-functions and detachable mechanism is developing presently. There are many kinds of conventional infant seats, and some infant seats are detachable. However, the detachable structure of the infant seat is often too complicated to operate, so that the conventional infant seat is not conducive to compete in the market.

### SUMMARY OF THE INVENTION

A purpose of the present invention is to provide a fast assembly mechanism with a simple structure to operate conveniently.

Another purpose of the present invention is to provide an infant seat with the fast assembly mechanism.

In order to achieve above purposes, the present invention is to provide a fast assembly mechanism installed between a seat frame and a seat body for assembling or disassembling the seat frame and the seat body. The fast assembly mechanism includes a pin and a connecting component. The pin is connected to the seat body. The connecting component is slidably disposed on the seat frame. The connecting component includes an engaging portion and a release portion. The engaging portion is for engaging with the pin, so as to engage the seat body with the seat frame. The release portion is communicated with the engaging portion, and the pin is passing through the release portion for separating from the connecting component as the connecting component is moved to a position where the pin is aligned to the release portion, so as to separate the seat body from the seat frame. Therefore, it can implement the engagement or the detachment of the seat body and the seat frame fast. An operation of the fast assembly mechanism is simple and convenient.

Preferably, a first connecting hole is formed on the seat body, a second connecting hole corresponding to the first connecting hole is formed on the seat frame, an end of the pin is connected to the seat body, and the other end of the pin is connected to the connecting component by passing through the first connecting hole and the second connecting hole in sequence.

Preferably, the fast assembly mechanism further includes a washer disposed on a bottom of the seat body and sheathing the pin, and the washer being for preventing the pin from separating from the seat body.

Preferably, the pin includes an engaging ring slot for engaging with the engaging portion.

Preferably, the engaging portion and the release portion are two holes communicated with each other, a diameter of engaging portion is greater than a diameter of the engaging ring slot and is less than an outer diameter of the pin, and a diameter of the release portion is greater than the outer diameter of the pin.

Preferably, a guiding portion is disposed at a free end of the pin, the guiding portion is connected to the engaging ring slot, an outer diameter of the guiding portion is reducing from a position where the guiding portion is connected to the engaging ring slot to the free end of the pin to form an inclined surface, and the outer diameter of guiding portion on the position where the guiding portion is connected to the engaging ring slot is greater than a diameter of the engaging ring slot.

Preferably, the guiding portion is a half-spherical structure or a cone-shaped structure.

Preferably, a guiding component is disposed on the seat frame, a guiding slot corresponding to the guiding component is formed on the connecting component, and the guiding slot and guiding component cooperatively guide the connecting component to slide relative to the seat frame, so as to constrain a sliding direction of the connecting component relative to the seat frame.

Preferably, the guiding slot is a strip-shaped opening, and the strip-shaped opening sheathes the guiding component. In this design, the connecting component can laterally slide along the guiding component through the strip-shaped opening to switch the engaging portion and the release portion, so as to implement the engagement or the detachment of the seat body and the seat frame.

Preferably, the guiding component is a screw or a rivet, and the guiding component passes through the strip-shaped opening and is engaged with the seat frame.

Preferably, the guiding component and the guiding slot are a sliding block and a sliding track respectively and cooperate with each other.

Preferably, the connecting component further includes an operation handle for driving the connecting component to move relative to the seat frame, so as to implement the engagement or the detachment of the seat body and the seat frame.

Preferably, the fast assembly mechanism further includes a resilient component connected to the connecting component and the seat frame for driving the connecting component to engage with the pin.

The present invention further provides an infant seat. The infant seat includes a seat body, a seat frame and a fast assembly mechanism. The fast assembly mechanism installed between the seat frame and the seat body for assembling or disassembling the seat frame and the seat body. The fast assembly mechanism includes a pin and a connecting component. The pin is connected to a seat body. The connecting component is slidably disposed on a seat frame. The connecting component includes an engaging portion and a release portion. The engaging portion is for engaging with the pin, so as to engage the seat body with the seat frame. The release portion is communicated with the engaging portion, and the pin is passing through the release portion for separating from the connecting component as the connecting component is moved to a position where the pin is aligned to the release portion, so as to separate the seat body from the seat frame. Therefore, it can implement the engagement or the detachment of the seat body and the seat frame fast.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of an infant seat according to an embodiment of the present invention.

FIG. 2 is a bottom view of the infant seat according to the embodiment of the present invention.

FIG. 3 is a diagram of a seat body according to the embodiment of the present invention.

FIG. 4 is a diagram of a seat frame according to the embodiment of the present invention.

FIG. 5 is a sectional view of a pin engaging with a connecting component according to the embodiment of the present invention.

FIG. 6 is a sectional view of the pin detaching from the connecting component according to the embodiment of the present invention.

FIG. 7 is a diagram of an engaging portion engaging with the pin according to the embodiment of the present invention.

FIG. 8 is a diagram of the engaging portion detaching from the pin according to the embodiment of the present invention.

### DETAILED DESCRIPTION

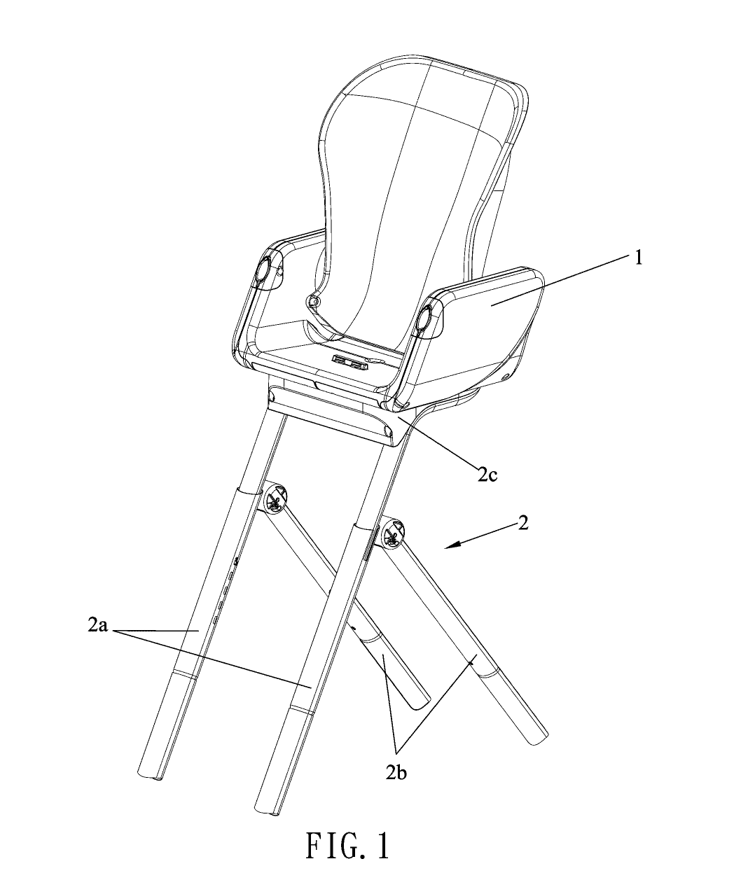

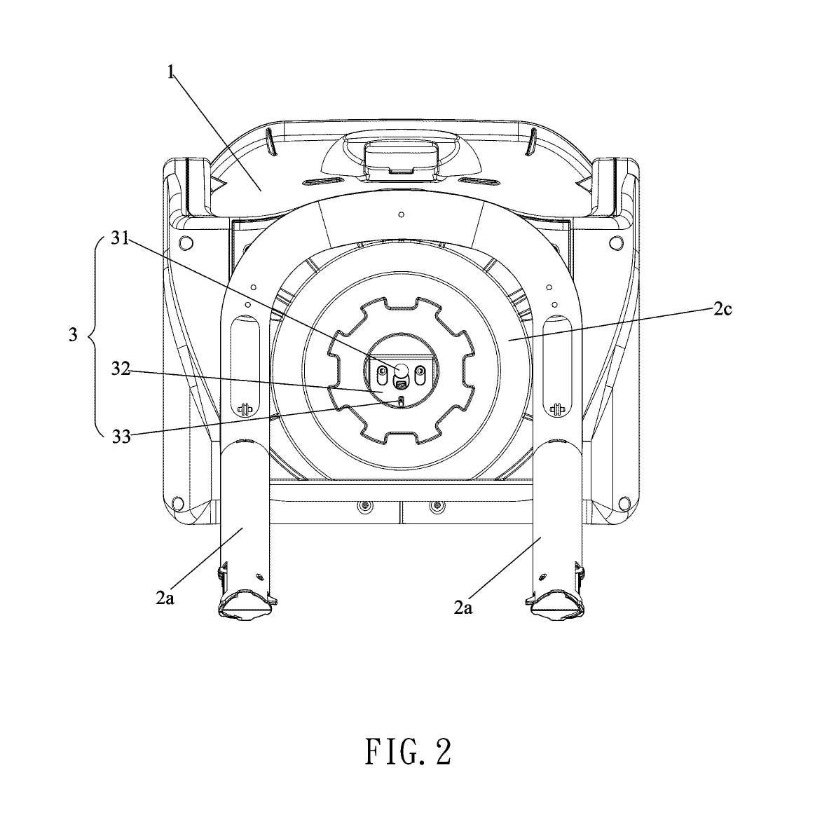

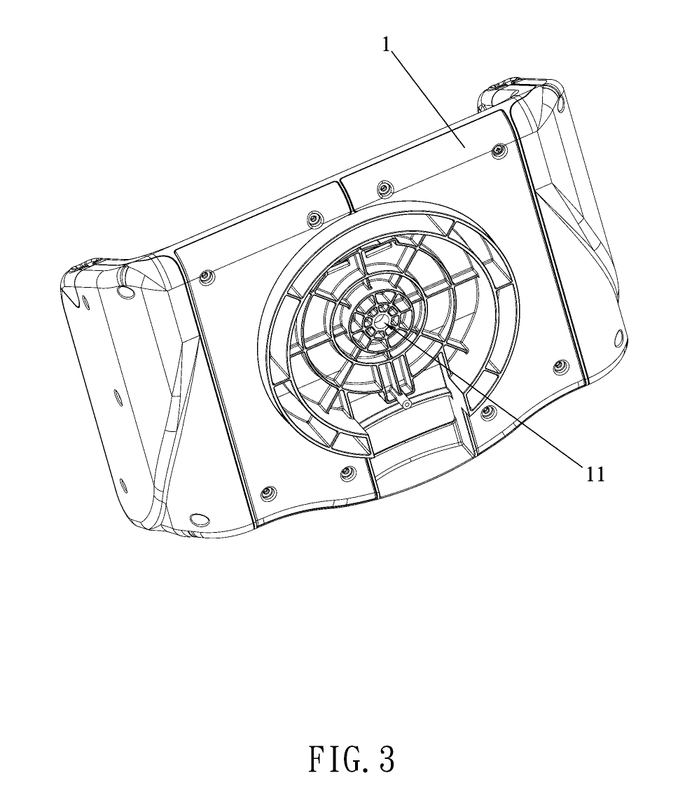

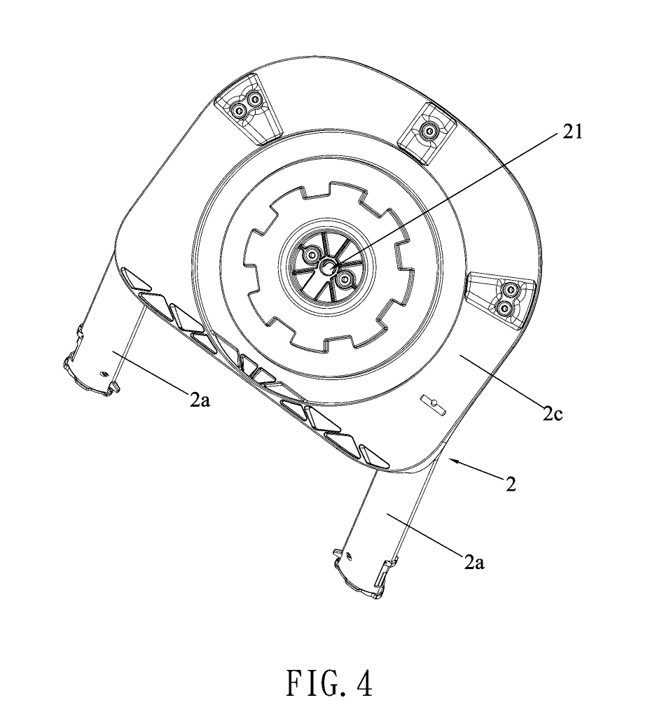

Please refer to FIG. 1 to FIG. 8. An infant seat includes a seat body 1, a seat frame 2 and a fast assembly mechanism 3. The seat body 1 is detachably installed on the seat frame 2 with the fast assembly mechanism 3. The fast assembly mechanism 3 is installed between the seat frame 2 and the seat body 1 for assembling or disassembling the seat frame 2 and the seat body 1, so as to achieve simple structure and convenient operation of the infant seat. In this embodiment, the seat frame 2 includes a front frame 2a, a rear frame 2b and a support plate 2c. The rear frame 2b is pivotally connected to the front frame 2a. The support plate 2c is fixed on a top end of the front frame 2a. The support plate 2c is for supporting the seat body 1, and the seat body 1 can be detachably disposed on the support plate 2c.

The fast assembly mechanism 3 includes a pin 31 and a connecting component 32. The pin 31 is connected to the seat body 1, and the connecting component 32 is slidably disposed on the seat frame 2. The connecting component 32 includes an engaging portion 321 and a release portion 322. The engaging portion 321 is for engaging with the pin 31, so as to engage the seat body 1 with the seat frame 2. The release portion 322 is communicated with the engaging portion 321. The release portion 322 is for separating from the connecting component 32 as the connecting component 32 is moved to a position where the pin 31 is aligned to the release portion 322, so as to separate the seat body 1 from the seat frame 2. When the seat body 1 is engaged with the seat frame 2, the pin 31 is engaged with the engaging portion 321. When the seat body 1 is detached from the seat frame 2, the pin 31 is passing through the release portion 322 to separate from the connecting component 32. Therefore, it can implement an engagement or a detachment of the seat body 1 and the seat frame 2 fast.

A first connecting hole 11 is formed on the seat body 1, and a second connecting hole 21 corresponding to the first connecting hole 11 is formed on the seat frame 2. An end of the pin 31 is connected to the seat body 1, and the other end of the pin 31 is connected to the connecting component 32 by passing through the first connecting hole 11 and the second connecting hole 21 in sequence. The fast assembly mechanism 3 further includes a washer 4 disposed on a bottom of the seat body 1 and sheathing the pin 31, and the washer 4 is for preventing the pin 31 from separating from the seat body 1. Thus, when the seat body 1 is separated from the seat frame 2, the pin 31 is still mounted on the seat body 1, so as to prevent loss of the pin 31. In addition, the pin 31 and the seat body 1 can be formed integrally in another embodiment, and it is not limited to the above-mentioned structure. In order to allow the seat body 1 to change directions when the seat body 1 is disposed on the seat frame 2, the pin 31 can be designed as a cylindrical structure. Therefore, the pin 31 can be as a pivotal shaft of the seat body 1, so that the seat body 1 can turn without separating from the seat frame 2. The pin 31 also can be formed as any kind of the columnar body, such as an elliptical columnar body, a rectangular columnar body, a polygonal columnar body and so on, without consideration for the function of changing directions relative to the seat frame 2. That is, the pin 31 is not limited to the cylindrical structure.

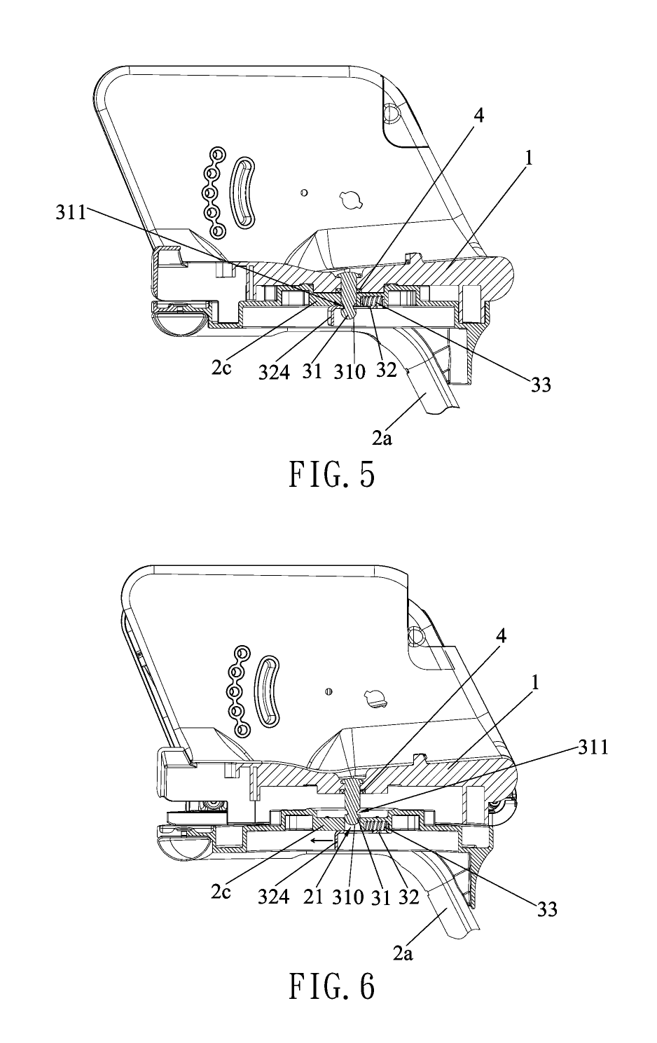

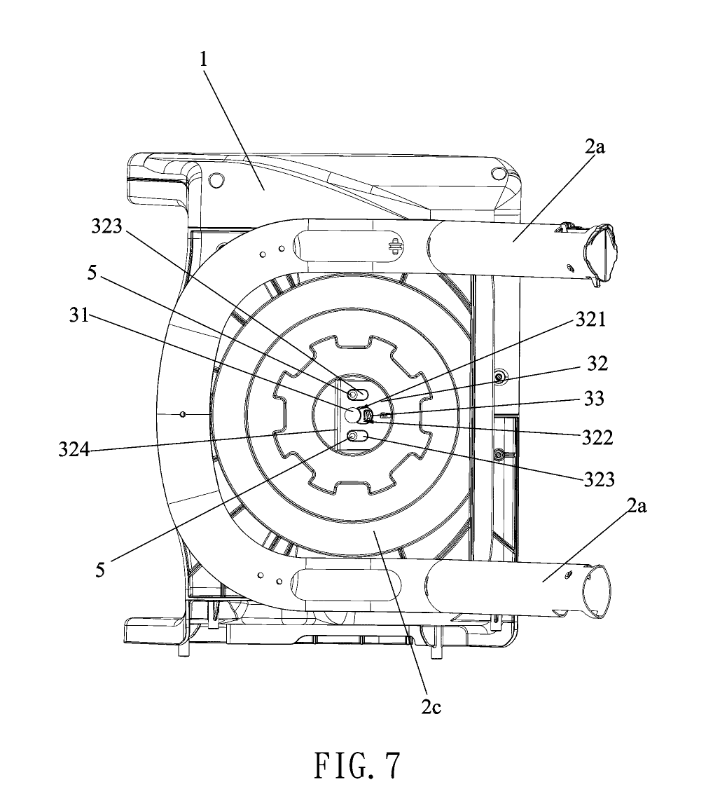

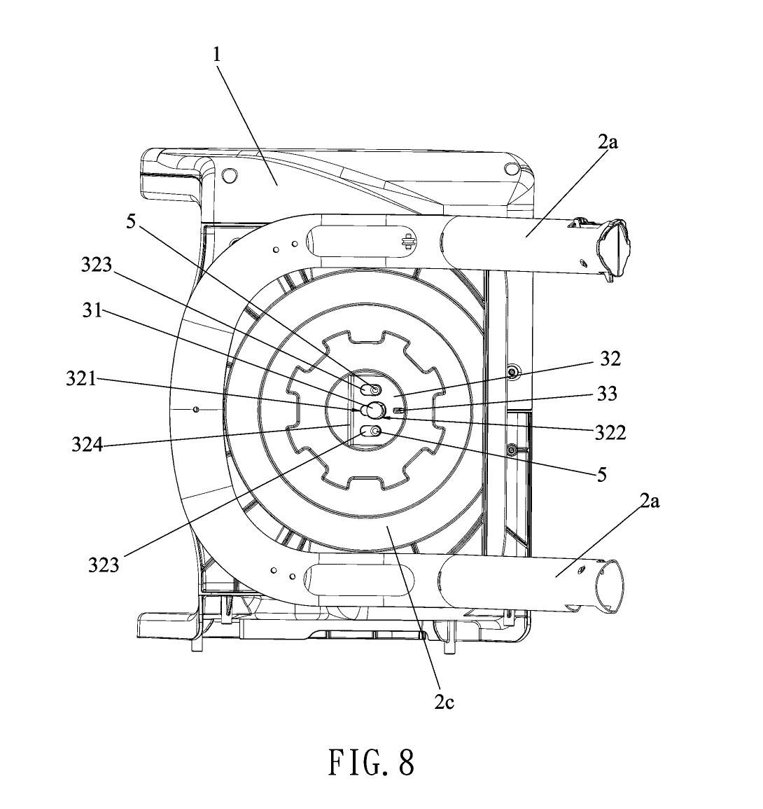

As shown in FIG. 5 and FIG. 7, the pin 31 includes an engaging ring slot 311 for engaging with the engaging portion 321. As shown in FIG. 5 to FIG. 8, the engaging portion 321 and the release portion 322 are two holes communicated with each other. A diameter of engaging portion 321 is greater than a diameter of the engaging ring slot 311 and is less than an outer diameter of the pin 31, and a diameter of the release portion 322 is greater than the outer diameter of the pin 31. As shown in FIG. 6, as the connecting component 32 is moving in an arrow direction, the engaging portion 321 and the release portion 322 are moving at the same time until the release portion 322 moves to a position corresponding to the second connecting hole 21, as shown in FIG. 8. At this time, the pin 31 can separate from the release portion 322, so as to implement a rapid detachment of the seat body 1 and the seat frame 2.

In order to install the pin 31 on the connecting component 32 easily, the pin 31 includes a guiding portion 310 illustrated in FIG. 5 and FIG. 6. The guiding portion 310 is disposed at a free end of the pin 31 and connected to the engaging ring slot 311. An outer diameter of the guiding portion 310 is reducing from a position where the guiding portion 310 is connected to the engaging ring slot 311 to the free end of the pin 31 to form an inclined surface, and the outer diameter of the guiding portion 310 on the position where the guiding portion 310 is connected to the engaging ring slot 311 is greater than the diameter of the engaging ring slot 311. The guiding portion 310 can be a half-spherical structure, but is not limited to this structure. For example, the guiding portion 310 can be a cone-shaped structure, a trapezoid-shaped structure, and so on. When the pin 31 is installed on the second connecting hole 21, a surface of the guiding portion 310 contacts against the connecting component 32 and pushes the connecting component 32 until the release portion 322 is aligned to the pin 31. Then, the guiding portion 310 passes through the connecting component 32. And then, the connecting component 32 engages with the engaging ring slot 311, and the pin 31 is located on the seat frame 2. The guiding portion 310 is for facilitating the pin 31 to push the connecting component 32 without dragging the connecting component 32, so as to increase efficiency of installing the seat body 1 on the seat frame 2.

A guiding component 5 is disposed on the seat frame 2, and the connecting component 32 is slidably connected to the seat frame 2 by the guiding component 5. A guiding slot 323 corresponding to the guiding component 5 is formed on the connecting component 32, and the guiding slot 323 and guiding component 5 cooperatively guide the connecting component 32 to slide relative to the seat frame 2. In this embodiment, the guiding slot 323 can be a strip-shaped opening, and the strip-shaped opening sheathes the guiding component 5. In this design, the connecting component 32 can horizontally slide along the guiding component 5 through the strip-shaped opening 323 to switch the engaging portion 321 and the release portion 322, so as to implement the engagement or the detachment of the seat body 1 and the seat frame 2. In this embodiment, the guiding component 5 can be a screw, and the screw passes through the strip-shaped opening and is engaged with the seat frame 2. The guiding component 5 also can be a rivet, a sleeve and so on. Besides, the guiding component 5 and the guiding slot 323 can be a sliding block and a sliding track respectively and cooperate with each other, to achieve a purpose of constraining a sliding direction of the connecting component 32 relative to the seat body 1. The sliding mechanism is not limited to this embodiment.

The connecting component 32 is connected to the seat frame 2 via a resilient component 33. Two ends of the resilient component 33 contact against the connecting component 32 and the seat frame 2 respectively, so that the connecting component 32 is engaged with pin 31. In this embodiment, the resilient component 33 can be a spring. The connecting component 32 includes an operation handle 324 for driving the connecting component 32 to move relative to the seat frame 2, so as to implement the engagement or the detachment of the seat body 1 and the seat frame 2. And an operation of the operation handle 324 is simple and convenient.

In contrast to the prior art, the prevent invention utilizes the pin 31 and the connecting component 32 to implement rapid engagement and detachment of the seat body 1 and the seat frame 2. The pin 31 is connected to the seat body 1, and the connecting component 32 is slidably disposed on the seat frame 2. The connecting component 32 includes the engaging portion 321 and the release portion 322. The engaging portion 321 is for engaging with the pin 31. The release portion 322 is for the pin 31 to separate from the connecting component 32. When the seat body 1 is engaged with the seat frame 2, the pin 31 is engaged with the engaging portion 321. When the seat body 1 is detached from the seat frame 2, the pin 31 is passing through the release portion 322 to separate from the connecting component 32. Therefore, it can implement the engagement or the detachment of the seat body 1 and the seat frame 2 fast. In addition, it is noticed that the pin 31 and the connecting component 32 can be disposed on the seat frame 2 and the seat body 1 reversely. That is, the pin 31 is disposed on the seat frame 2, and the connecting component 32 is disposed on the seat body 1. Related components can perform opposite displacement to achieve the same purpose of this embodiment, and detailed description is omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fast assembly mechanism, comprising:
a pin connected to a seat body; and
a connecting component slidably disposed on a seat frame, the connecting component comprising:
an engaging portion for engaging with the pin, so as to engage the seat body with the seat frame; and
a release portion communicated with the engaging portion, the pin passing through the release portion for separating from the connecting component as the connecting component is moved to a position where the pin is aligned to the release portion, so as to separate the seat body from the seat frame.

2. The fast assembly mechanism of claim 1, wherein a first connecting hole is formed on the seat body, a second connecting hole corresponding to the first connecting hole is formed on the seat frame, an end of the pin is connected to the seat body, and the other end of the pin is connected to the connecting component by passing through the first connecting hole and the second connecting hole in sequence.

3. The fast assembly mechanism of claim 2, further comprising a washer disposed on a bottom of the seat body and sheathing the pin, and the washer being for preventing the pin from separating from the seat body.

4. The fast assembly mechanism of claim 1, wherein the pin comprises an engaging ring slot for engaging with the engaging portion.

5. The fast assembly mechanism of claim 4, wherein the engaging portion and the release portion are two holes communicated with each other, a diameter of engaging portion is greater than a diameter of the engaging ring slot and is less than an outer diameter of the pin, and a diameter of the release portion is greater than the outer diameter of the pin.

6. The fast assembly mechanism of claim 4, wherein a guiding portion is disposed at a free end of the pin, the guiding portion is connected to the engaging ring slot, an outer diameter of the guiding portion is reducing from a position where the guiding portion is connected to the engaging ring slot to the free end of the pin to form an inclined surface, and the outer diameter of guiding portion on the position where the guiding portion is connected to the engaging ring slot is greater than a diameter of the engaging ring slot.

7. The fast assembly mechanism of claim 6, wherein the guiding portion is a half-spherical structure or a cone-shaped structure.

8. The fast assembly mechanism of claim 1, wherein a guiding component is disposed on the seat frame, a guiding slot corresponding to the guiding component is formed on the connecting component, and the guiding slot and guiding component cooperatively guide the connecting component to slide relative to the seat frame, so as to constrain a sliding direction of the connecting component relative to the seat frame.

9. The fast assembly mechanism of claim 8, wherein the guiding slot is a strip-shaped opening, and the strip-shaped opening sheathes the guiding component.

10. The fast assembly mechanism of claim 9, wherein the guiding component is a screw or a rivet, and the guiding component passes through the strip-shaped opening and is engaged with the seat frame.

11. The fast assembly mechanism of claim 8, wherein the guiding component and the guiding slot are a sliding block and a sliding track respectively and cooperate with each other.

12. The fast assembly mechanism of claim 1, wherein the connecting component further comprises an operation handle.

13. The fast assembly mechanism of claim 1, further comprising a resilient component connected to the connecting component and the seat frame for driving the connecting component to engage with the pin.

14. An infant seat, comprising:
a seat body;
a seat frame; and
a fast assembly mechanism installed between the seat frame and the seat body for assembling or disassembling the seat frame and the seat body, the fast assembly mechanism comprising:
a pin connected to a seat body; and
a connecting component slidably disposed on a seat frame, the connecting component comprising:
an engaging portion for engaging with the pin, so as to engage the seat body with the seat frame; and
a release portion communicated with the engaging portion, the pin passing through the release portion for separating from the connecting component as the connecting component is moved to a position where the pin is aligned to the release portion, so as to separate the seat body from the seat frame.

15. The infant seat of claim 14, wherein a first connecting hole is formed on the seat body, a second connecting hole corresponding to the first connecting hole is formed on the seat frame, an end of the pin is connected to the seat body, and the other end of the pin is connected to the connecting component by passing through the first connecting hole and the second connecting hole in sequence.

16. The infant seat of claim 15, further comprising a washer disposed on a bottom of the seat body and sheathing the pin, and the washer being for preventing the pin from separating from the seat body.

17. The infant seat of claim 14, wherein the pin comprises an engaging ring slot for engaging with the engaging portion.

18. The infant seat of claim 17, wherein the engaging portion and the release portion are two holes communicated with each other, a diameter of engaging portion is greater than a diameter of the engaging ring slot and is less than an outer diameter of the pin, and a diameter of the release portion is greater than the outer diameter of the pin.

19. The infant seat of claim 17, wherein a guiding portion is disposed at a free end of the pin, the guiding portion is connected to the engaging ring slot, an outer diameter of the guiding portion is reducing from a position where the guiding portion is connected to the engaging ring slot to the free end of the pin to form an inclined surface, and the outer diameter of guiding portion on the position where the guiding portion is connected to the engaging ring slot is greater than a diameter of the engaging ring slot.

20. The infant seat of claim 14, wherein a guiding component is disposed on the seat frame, a guiding slot corresponding to the guiding component is formed on the connecting component, and the guiding slot and guiding component cooperatively guide the connecting component to slide relative to the seat frame, so as to constrain a sliding direction of the connecting component relative to the seat frame.
